(19) United States
(12) Patent Application Publication
(10) Pub. No.: US 2003/0019194 A1
(43) Pub. Date: Jan. 30, 2003

(54) Filter screen device having a solid configuration

(76) Inventor: Pai Yung Lin, Chong Ho City (TW)

Correspondence Address: Pai Yung LIN, P.O. Box 10-69, Chong Ho, Taipei, 235, TW

(21) Appl. No.: 09/915,322

(22) Filed: Jul. 27, 2001

(51) Int. Cl. B01D 46/00

(52) U.S. Cl. 55/495; 55/524

(57) ABSTRACT

A filter screen device includes a number of fibers having a number of longitudinal and lateral lines intersected with each other to form a spider line device and to form a planer sheet, and to form a number of areas in the planer sheet, and for securing the fibers together, and thus for preventing the fibers from being disengaged from the filter screen device. The filter screen device may be formed into a planer shape for engaging into the air conditioners, the dehumidifiers, or may be made as the mop members, or may be formed into the filter devices for the faucets.

### BACKGROUND OF THE INVENTION

1. Field of the Invention

The present invention relates to a filter screen, and more particularly to a filter screen device having a solid configuration for preventing the cotton fibers or the cotton waddings or the other fibers from being disengaged from the filter screen device.

2. Description of the Prior Art

Typical filter screen devices, particularly the filter screen devices for attaching into the air conditioner apparatus, are made of the cotton fibers or the cotton waddings or the other fibers that are adhered together or compressed together into a planer shape. The cotton fibers or the cotton waddings or the other fibers for the typical filter screen devices may not be solidly secured together and may be easily disengaged from the typical filter screen device after use, and may thus be blown into the building.

The present invention has arisen to mitigate and/or obviate the afore-described disadvantages of the conventional filter screen devices.

### SUMMARY OF THE INVENTION

The primary objective of the present invention is to provide a filter screen device including a solid configuration for preventing the cotton fibers or the cotton waddings or the other fibers from being disengaged from the filter screen device.

In accordance with one aspect of the invention, there is provided a filter screen device comprising a number of fibers including a spider line device formed therein for securing the fibers together, and for forming into a planer sheet, and for forming a plurality of areas in the planer sheet, and for securing the fibers together, and thus for preventing the fibers from being disengaged from the filter screen device. The filter screen device may be formed into the planer structure for engaging into the air conditioner facilities, the dehumidifier facilities, or may be made as the mop members, or may be formed into the filter devices for the faucets.

An adhesive material or the like may further be provided for securing the fibers together and for further preventing the fibers from being disengaged from the filter screen device.

The spider line device includes a plurality of longitudinal lines and a plurality of lateral lines intersecting with each other for forming the areas in the planer sheet. The fibers may include a static electricity for facilitating the filtering effect of the filter screen device.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a plane schematic view of a filter screen device in accordance with the present invention;

FIG. 2 is an enlarged plane schematic view showing the cotton fibers or the cotton waddings of the filter screen device;

FIG. 3 is an enlarged partial perspective view of the filter screen device;

FIG. 4 is an enlarged plane schematic view showing the cotton fibers or the cotton waddings or the other fibers for the filter screen device;

FIG. 5 is a schematic view illustrating the operation of the filter screen device;

FIG. 6 is an exploded view illustrating the attachment of the filter screen device to the air conditioner; and

FIGS. 7, 8, 9 are perspective views illustrating the operation of the filter screen device.

### DETAILED DESCRIPTION OF THE PREFERRED EMBODIMENT

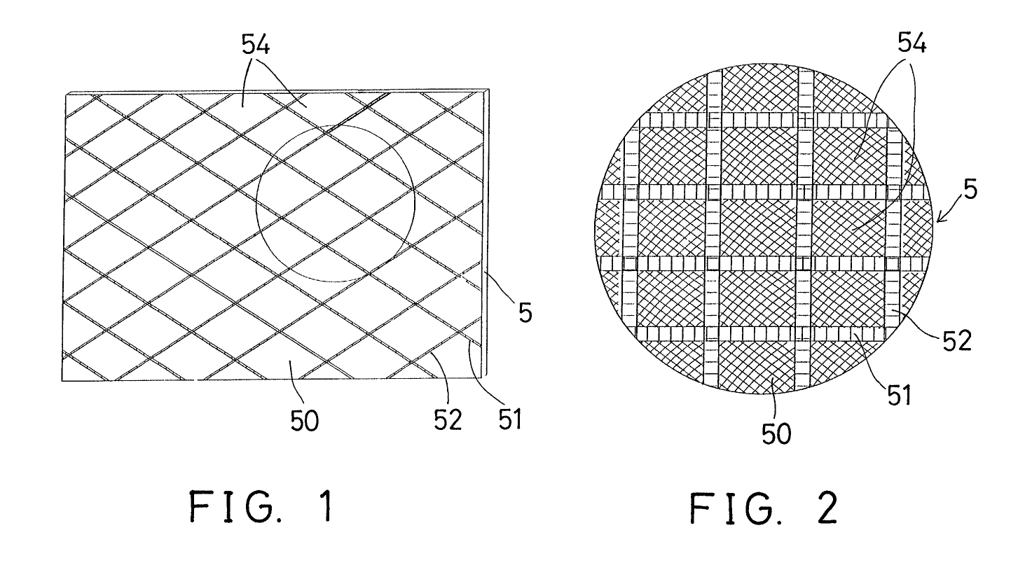

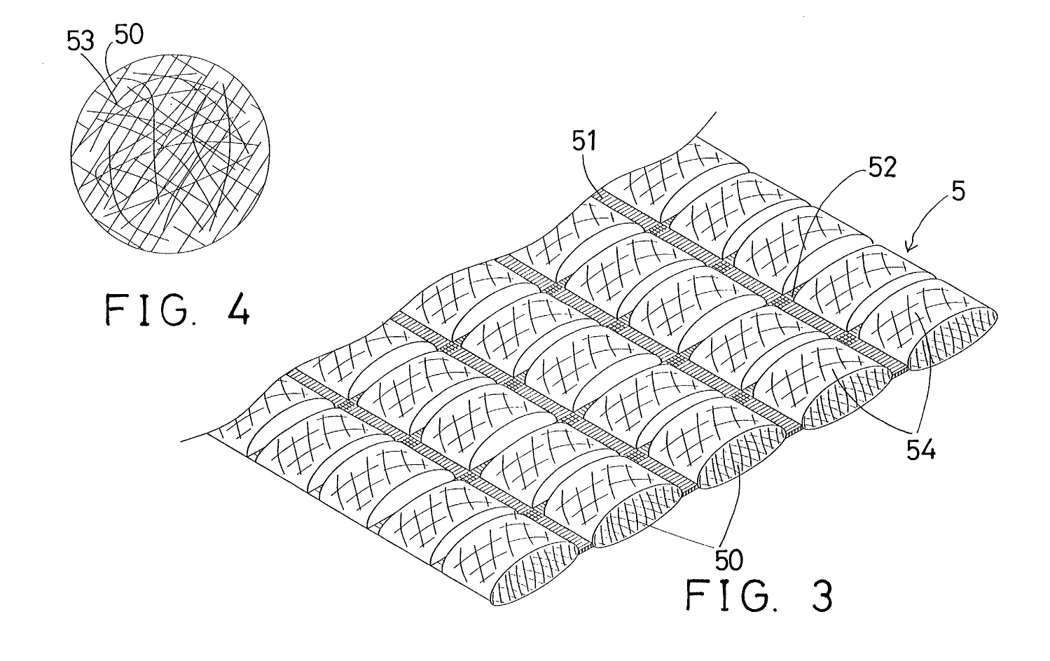

Referring to the drawings, and initially to FIGS. 1-4, a filter screen device 5 in accordance with the present invention comprises a number of strings and/or yarns and/or fibers 50 randomly disposed together, and secured together with a spider line device 51, 52 that has a number of coupling or securing or welding lines 51, 52 and that may be formed by ultrasonic welding processes or the like, in order to form a sheet or a planer structure or configuration having a number of areas 54 formed therein. The spider welding lines 51, 52 include a number of longitudinal or lateral lines 51 and a number of lateral or longitudinal lines 52 that are intersected or straddled with each other in order to form the areas 54 that are preferably rectangular or square or parallelogrammic in shape. The fibers 50 may thus be solidly secured together and will not be disengaged from the filter screen device after use.

As best shown in FIG. 4, the fibers 50 may further be secured together with adhesive materials 53 that are provided or applied to the coupling portions or the intersecting portions of the fibers 50, for further solidly securing the fibers 50 together. The adhesive materials 53 will not block the apertures or the orifices formed between the fibers 50. The filter screen device may thus include a number of strings and/or yarns and/or fibers 50 compressed into the sheet or the planer structure or configuration having a high density and a less thickness.

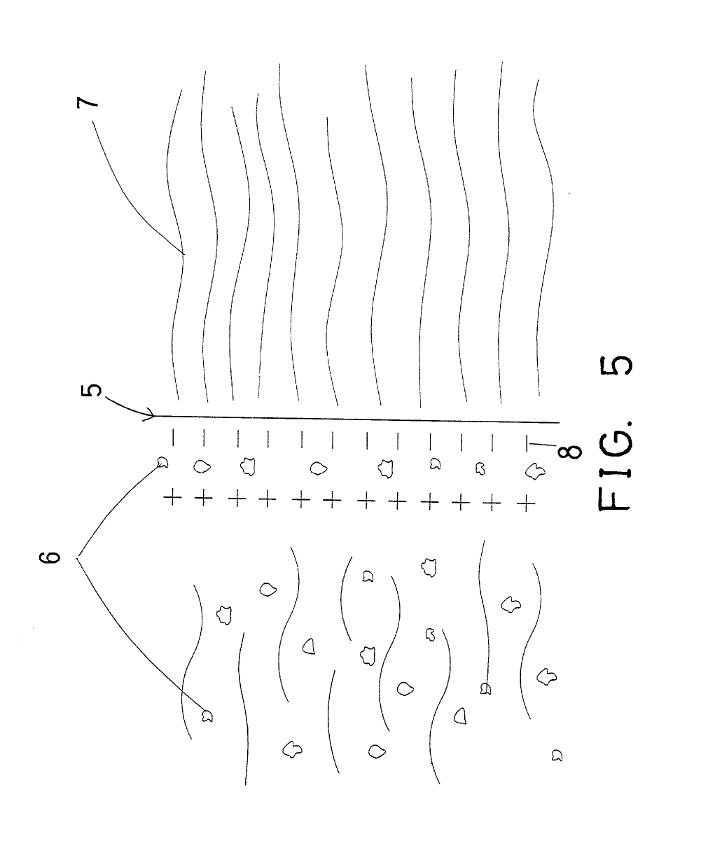

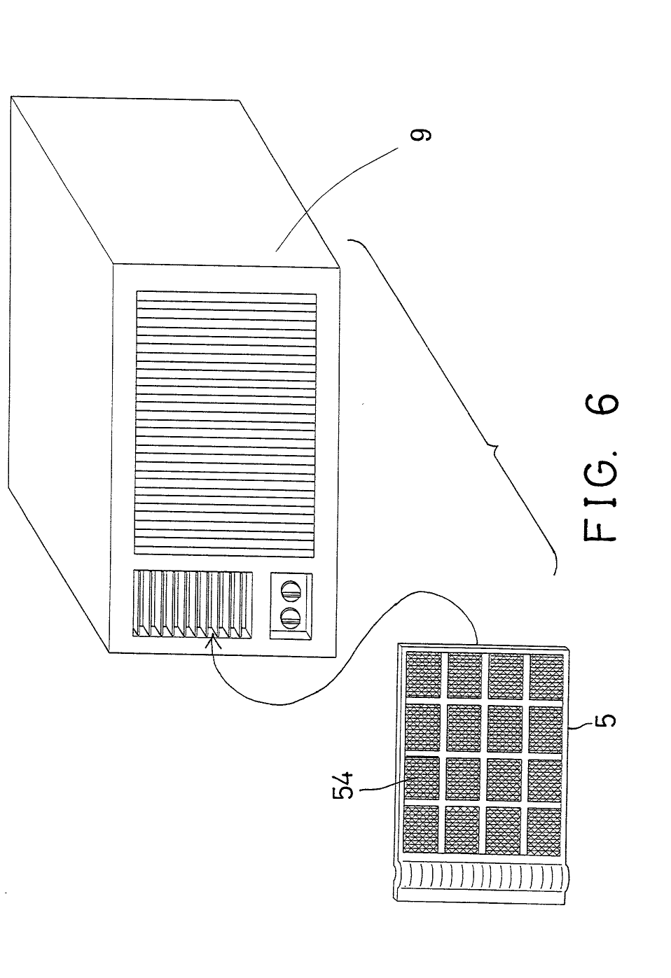

Referring next to FIG. 5, the fibers of the filter screen device 5 are preferably made of the fibers that have static electricity 8 for filtering the dust, the germs, the hair or feather, the pollen, or the other contaminants 6, and for allowing only the fresh air 7 to flow through the filter screen device 5.

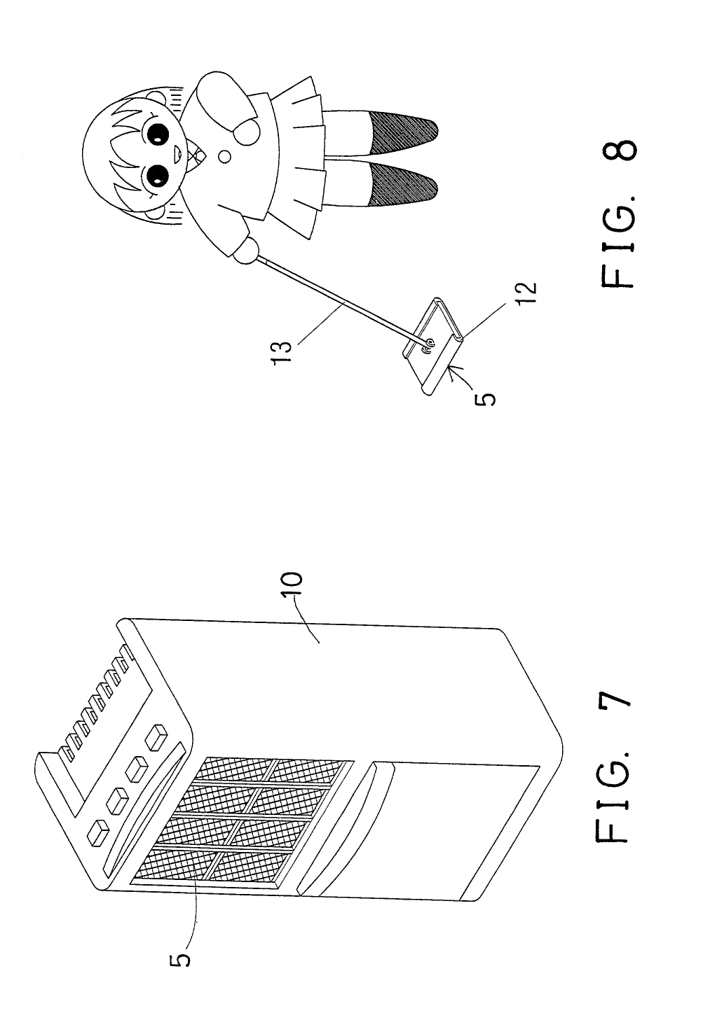

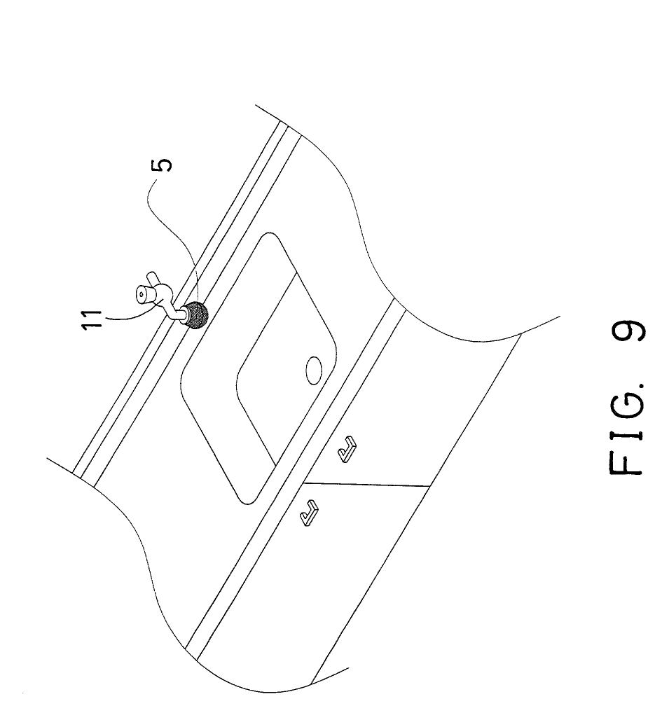

In operation, as shown in FIGS. 6 and 7, the filter screen device 5 may be manufactured or formed into the sheet or the planer structure or configuration and may be engaged into the air conditioner facilities 9 (FIG. 6), or into the dehumidifier facilities 10 (FIG. 7) for filtering purposes. As shown in FIG. 8, the filter screen device 5 may also be manufactured or formed into or as the mop member 12 of the mop device 13. As shown in FIG. 9, the filter screen device 5 may also be manufactured or formed into the water pacifier or the filter device for the faucet 11, for filtering the water.

Accordingly, the filter screen device in accordance with the present invention includes a solid configuration for preventing the cotton fibers or the cotton waddings or the other fibers from being disengaged from the filter screen device.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A filter screen device comprising:
a plurality of fibers including a spider line device formed therein for securing said fibers together, and for forming into a planer sheet, and for forming a plurality of areas in said planer sheet, and for securing said fibers together.

2. The filter screen device according to claim 1 further comprising an adhesive material for securing said fibers together.

3. The filter screen device according to claim 1, wherein said spider line device includes a plurality of longitudinal lines and a plurality of lateral lines intersecting with each other for forming said areas in said planer sheet.
